(19) United States
(12) Patent Application Publication
(10) Pub. No.: US 2010/0088015 A1
(43) Pub. Date: Apr. 8, 2010

(54) Navigation System Having Simplified Display Mode and Display Method Thereof

(75) Inventor: Ming-Chang Lee, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/570,475

(22) Filed: Sep. 30, 2009

(30) Foreign Application Priority Data
Oct. 2, 2008 (TW) 097137913

(51) Int. Cl. G01C 21/36

(52) U.S. Cl. 701/200

(57) ABSTRACT

A navigation system is provided. The navigation system operates in a normal operating mode and a simplified mode. The navigation system includes a processing module and a display module. When the navigation system operates in the normal operating mode, the processing module generates display content, which comprises a plurality of geographic information layers to display road information. The display module displays the display content on a display screen. When the navigation system operates in the simplified display mode, the processing module omits partial display content, such as partial geographic information layers, to generate simplified display content. The display module displays the simplified display content on the display screen.

### CROSS REFERENCE TO RELATED PATENT APPLICATION

This patent application is based on Taiwan, R.O.C. patent application No. 97137913 filed on Oct. 2, 2008.

### FIELD OF THE INVENTION

The present invention relates to a navigation system, and more particularly, to a navigation system omitting partial display content of a normal operating mode to generate simplified display content.

### BACKGROUND OF THE INVENTION

A portable navigation device (PND), which is a portable navigation system and widely applied to handheld devices and automobiles, provides various and convenient navigation capabilities. The portable navigation system captures related information and information of a point of interest (POI) from a geographic information database according to a positioning result. The information is displayed on a display screen and is provided to a user for reference. Further, the portable navigation device plans a best route that links a start point with an end point set by the user, and indicates a motion direction and a distance. FIG. 1 is a general navigation display screen, which indicates information such as a motion direction, a distance, a speed, a time, a planned route, nearby streets, a POI and so on. However, while providing powerful capabilities, the display screen of the portable navigation device can become rather complicated. Such a complicated screen is not convenient to use when the user is driving as the driving user may not be able to focus on identifying the information provided on the display screen. Therefore, it would be desirable to provide an information system capable of simplifying display content of a normal operating mode and displaying the simplified display content on a display screen.

### SUMMARY OF THE INVENTION

In view of the foregoing issues, one object of the present invention is to provide a navigation system having a normal operating mode and a simplified display mode, and a method thereof. When operating in the simplified display mode, the navigation system omits partial display content of the normal operating mode, so as to generate simplified display content.

The simplified display mode according to the present invention effectively displays information needed by a user and better enables the user to obtain necessary information quickly and easily. When the simplified display mode is applied to an in-car system, such as an in-car navigation device, driving safety is improved. Moreover, information such as a navigation route is projected on a windshield by integrating the in-car system with a head-up display (HUD). Simplified information projected on the windshield in front of a driver seat shall not undesirably influence the sight of a driver. Consequently, it is both safe and convenient to drive with the in-car navigation device.

A display method of a navigation system is provided according to an embodiment of the present invention. The display method comprises steps of displaying display content on a display screen in a normal operating mode, wherein the display content comprises a plurality of geographic information layers; and omitting partial geographic information layers to generate simplified display content and displaying the simplified display content on the display screen in a simplified display mode.

A navigation system having a normal operating mode and a simplified display mode is provided according to another embodiment of the present invention. The navigation system comprises a processing module, and a display module coupled to the processing module. When the navigation system operates in the normal operating mode, the processing module generates display content, which comprises a plurality of geographic information layers of road information, and the display module displays the display content on a display screen. When the navigation system operates in the simplified display mode, the processing module omits partial geographic information layers to generate simplified display content, and the display module displays the simplified display content on the display screen.

A navigation system having a simplified display mode according to the present invention facilitates a user to easily and instantly grasp necessary driving information so as to focus on practical on-road situations. Therefore, the navigation system according to the present invention can improve on-road safety and has great user convenience.

### BRIEF DESCRIPTION OF THE DRAWINGS

FIG. 1 is a schematic diagram of a navigation device of the prior art.

FIG. 2 is a schematic diagram of a navigation system having a normal operating mode and a simplified display mode in accordance with an embodiment of the present invention.

FIG. 3 is a schematic diagram of simplified display content according to an embodiment.

FIG. 4 is a schematic diagram of a geographic information classifying method.

FIG. 5 (a) to FIG. 5 (c) are schematic diagrams of displaying different numbers of vertexes to form a route.

FIG. 6 shows a result of having rotated the simplified display content illustrated in FIG. 3 with a specific angle.

FIG. 7 is a schematic diagram of projecting the screen illustrated in FIG. 6 onto a windshield of an automobile in accordance with an embodiment of the present invention.

### DETAILED DESCRIPTION OF THE PREFERRED EMBODIMENT

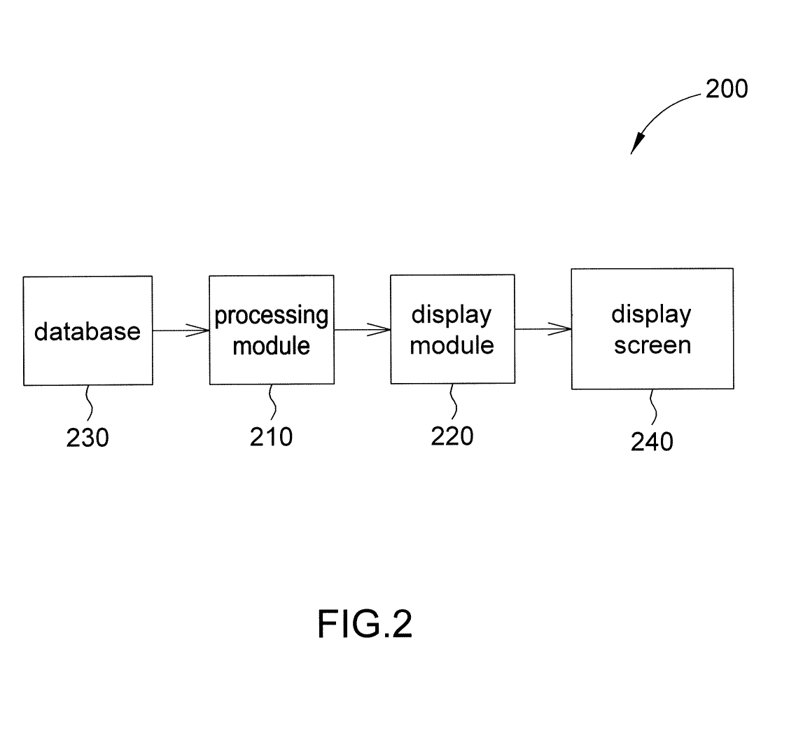

FIG. 2 shows a schematic diagram of a navigation system having a normal operating mode and a simplified display mode in accordance with an embodiment of the present invention. A navigation system 200 comprises a processing module 210 and a display module 220. The processing module 210, coupled to a database 230, captures information stored in the database 230 and processes the same to generate display content. In the normal operating mode, the display content of the processing module 210 is controlled by the display module 220 and is displayed on a display screen 240. However, when the navigation system 200 operates in the simplified display mode, the processing module 210 omits partial display content corresponding to the normal operating mode to generate simplified display content, which is displayed on the display screen 240 by the display module 220.

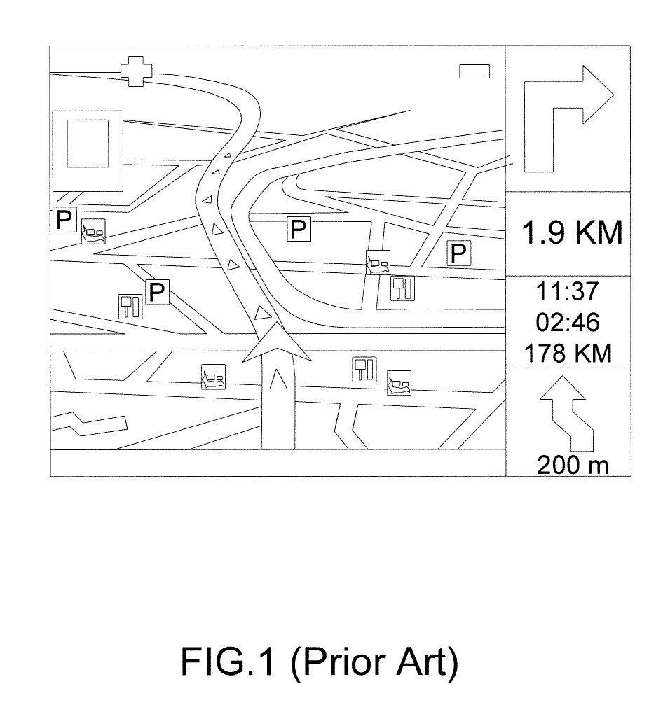

For example, in the normal operating mode, the processing module 210 builds a navigation map according to a positioning result and geographic information stored in the database 230. The navigation map, displayed on the display screen 240 as shown in FIG. 1, comprises a plurality of types of information, such as a motion direction, a distance, traveling speed, time, a planned route, nearby streets, a POI and so on. The information can be provided to a user such as a driver for reference. Implementation of the normal operating mode is known to a person having ordinary skills in the art, and hence a detailed description of generating the display content of the normal operating mode shall not be discussed for brevity.

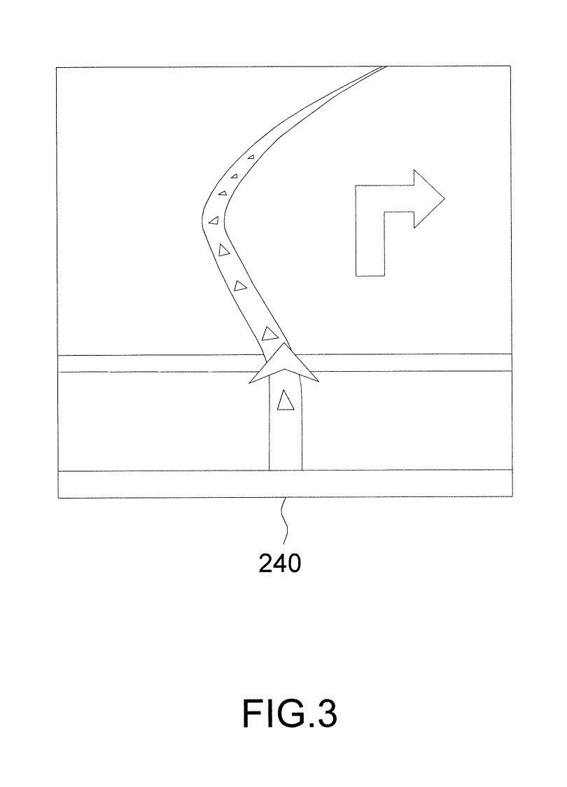

When the navigation system 200 switches to the simplified display mode, the processing module 210 omits unnecessary information of the display content illustrated in FIG. 1, so as to generate the simplified display content as shown in FIG. 3. In this embodiment, compared to the complete navigation map shown in FIG. 1, the simplified display content only comprises a planned route and direction instructions. Other information such as speed, time, nearby roads and a POI shall not be displayed, nor roads that are not on the planned route. The direction instructions are displayed in a special display manner, such as zooming in the screen, changing color or moving a display position near to the planned route, so as to facilitate receipt of the information by the user. Furthermore, it is not necessary to display practical on-road situations or bend angles when depicting the planned route, provided that the user clearly knows which road to drive on or which direction to turn to when coming to a crossroad.

The processing module 210 implements different routing algorithms corresponding to the normal operating mode and the simplified display mode to simplify the display content. The routing algorithm used in the normal operating mode applies a conventional routing algorithm as mentioned above, and the routing algorithm used in the simplified display mode is adjusted according to the conventional routing algorithm. For example, after information is accessed from the database 230 and the route is planned, road information that is not from a same geographic information layer as the planned route is omitted, or information except the planned route and direction instruction signs is omitted to generate the simplified display content.

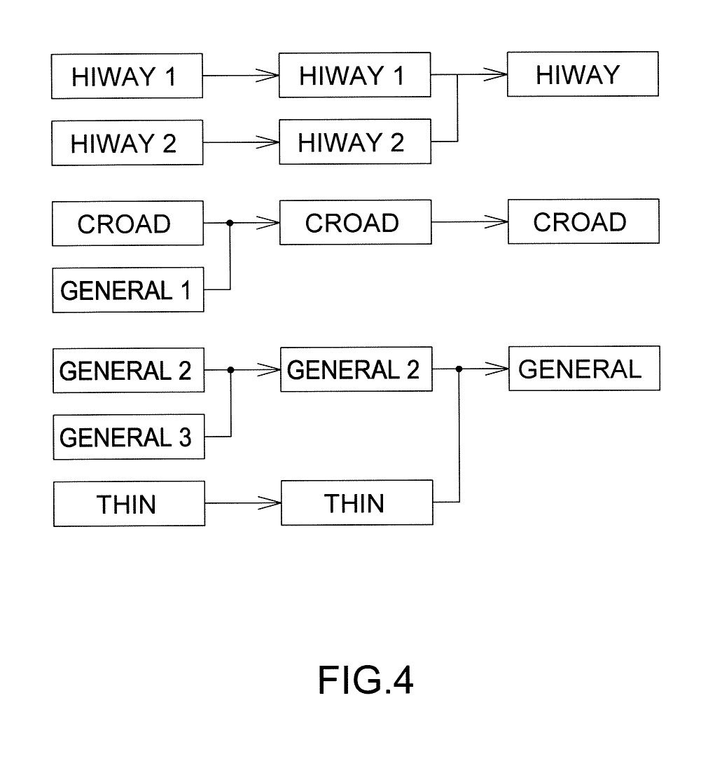

FIG. 4 is a schematic diagram of a geographic information classifying method, showing operations of omitting road information of different geographic information layers. HIWAY1 and HIWAY2 represent two groups of highways respectively, such as a longitudinal highway and an east-west highway. CROAD represents a provincial road, and GENERAL1, GENERAL2 and GENERAL3 represent three groups of provincial roads respectively. Classified according to the size of roads, THIN represents a lane. A layer of HIWAY is composed of HIWAY1 and HIWAY2, a layer of CROAD is composed of CROAD and GENERAL1, and a layer of GENERAL is composed of GENERAL2, GENERAL3, and THIN. In the normal operating mode, a road adjacent to a current route, regardless which layer the road belongs to, shall be displayed on the display screen 240. However, in the simplified display mode, the processing module 210 only allows roads of the same layer to which a currently on-route road belongs to be in the display content, so as to simplify information received by the driver to generate the simplified display content. For example, when the user drives on a highway and starts the simplified display mode, nearby urban roads are not displayed on the display screen 240 of the navigation system 200 because the highway and the urban roads are road information of different geographic information layers. The driver can better focus on the display content of the display screen 240. Moreover, when the user leaves the highway and enters an urban area, urban roads instead of the highway are preferably displayed on the display screen 240.

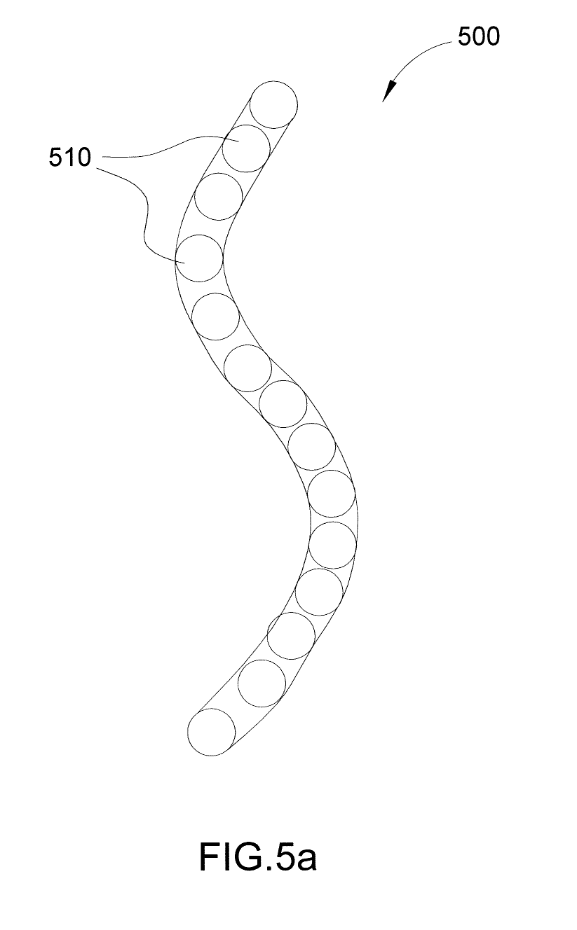

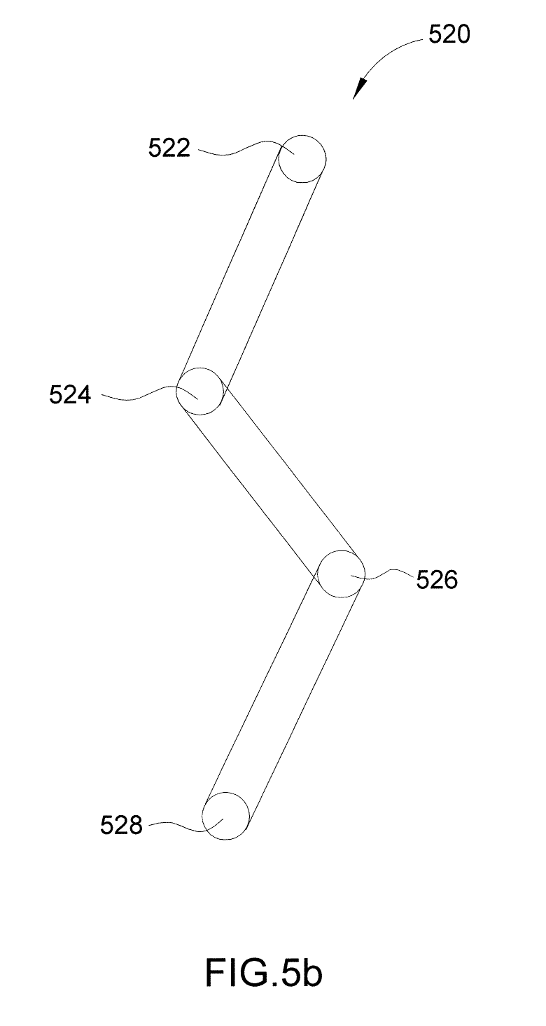

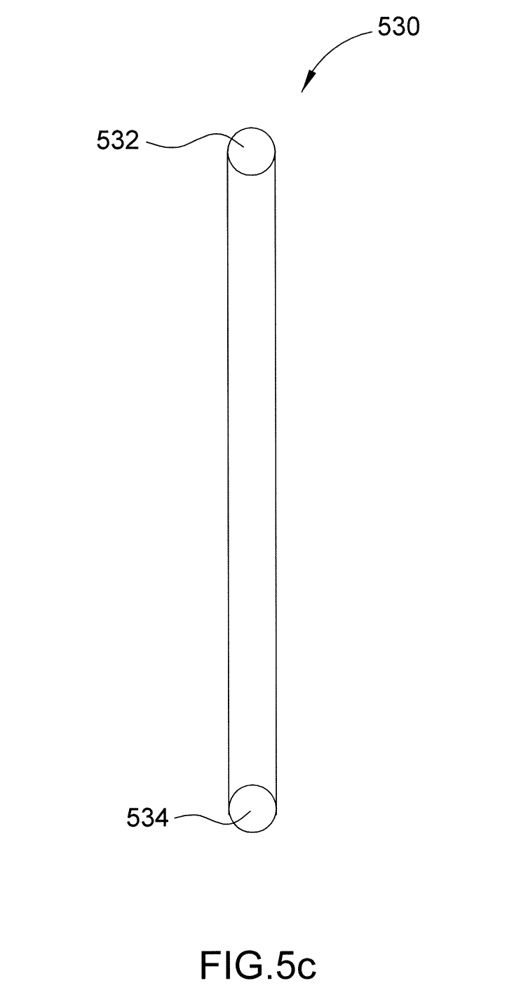

In addition, in the normal operating mode, referring to FIG. 5a, a link 500 displayed on the display screen 240 is composed of various vertexes 510, which shows in detail the bending extent of the link 500. However, not all of the vertexes 510 need to be included in the simplified display content. FIG. 5b shows an embodiment in which the navigation system 200 chooses partial specific vertexes on a link 520 from the database 230. FIG. 5c shows another embodiment in which the navigation system 200 only uses a start point 532 and an end point 534 of a link 530 to display basic information of the link 530.

It is to be noted that, the simplified display mode is different from a zooming in/out function of a conventional electronic map. Compared to a greater or a smaller map range after the electronic map is zoomed in or zoomed out, displayed map ranges of the navigation system 200 operating in the normal operating mode and the simplified display mode are the same; however, the simplified display mode omits partial display content to only display necessary information on the display screen, so as to enable the user to obtain the necessary driving information more quickly and easily. Furthermore, driving vision is not influenced and driving safety is not jeopardized when integrating the navigation system 200 with an HUD function.

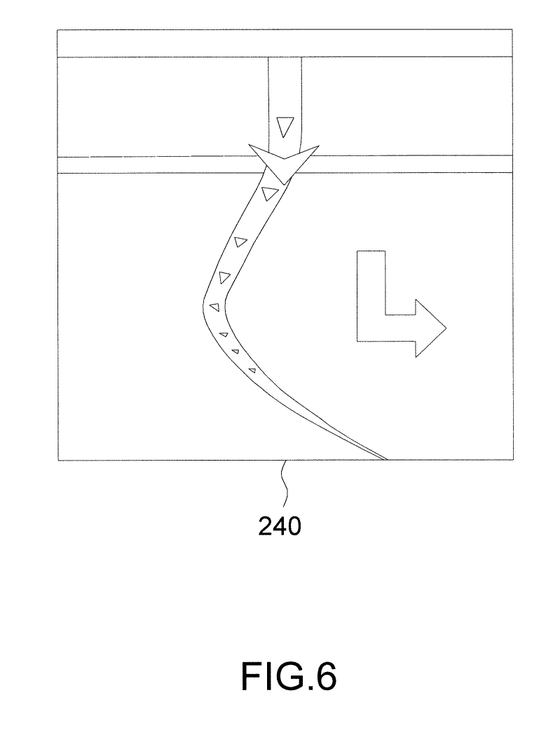

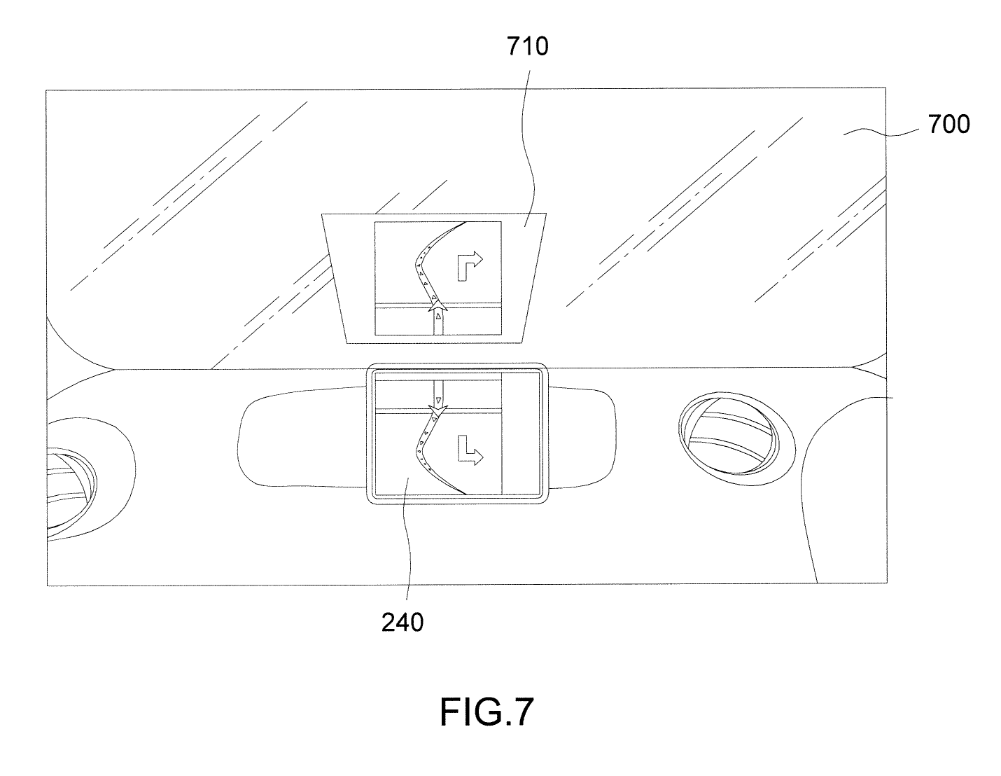

The operating mode of the navigation system 200, such as the normal operating mode and the simplified display mode, is switched according to user demand, or is automatically switched to the simplified display mode when the navigation system 200 is integrated with the HUD function. The HUD function is implemented via projection and optical reflection. Therefore, when the simplified display content is displayed, the display module 220 needs to display a result of rotating the simplified display content with a specific angle on a display screen 240, such as rotating with 180 degrees as shown in FIG. 6. FIG. 7 is a schematic diagram of projecting the display screen 240 on a half transparent reflector 710 of a windshield 700 in front of a driver seat. The display navigation map is simplified, and hence sight of the driver is not overly impacted and safety and convenience are both effectively enhanced.

The navigation system 200 further has an interaction capability. The user controls operations of the navigation system 200 and display of the display screen 240 via a control command such as a voice or a gesture. In an embodiment, the display screen 240 has a touch panel. The user enters a command via the touch panel to make a display navigation map move up or down, left or right. Note that when the display screen 240 displays the result of rotating the simplified display content with the specific angle, the processing module 210 receives a control command comprising an instruction direction, such as the foregoing direction of moving up or moving down, to update the display screen 240. The processing module 210 correspondingly updates the display screen 240 according to a direction of the instruction direction of rotating with the specific angle. That is, in this embodiment, the display screen 240 displays the result of rotating the simplified display content with 180 degrees. When the control command indicates the display screen 240 to move down, the display module 220 shall correspondingly move up the display screen and a result of moving down the display screen 240 is generated on the reflector 710.

In conclusion, a navigation system having a simplified display mode according to the present invention enables a user to more easily obtain necessary driving information and focus on practical on-road situations. Therefore, the navigation system according to the present invention can improve on-road driving safety especially during high-speed driving. In addition, the user can easily find driving information as needed on the display screen of the navigation system according to the present invention, and hence the navigation system has great user convenience.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display method of a navigation system, comprising:
in a normal operating mode, displaying display content on a display screen which comprises a plurality of geographic information layers for displaying road information; and
in a simplified display mode, omitting partial geographic information layers to generate simplified display content, and displaying the simplified display content on the display screen.

2. The display method as claimed in claim 1, wherein the display screen displays a result of having rotated the simplified display content with a predetermined angle.

3. The display method as claimed in claim 2, wherein the step of simplifying the display content by the navigation system in the normal operating mode comprising:
omitting road information that is not of a same geographic information layer, to which a route planned by the navigation system belongs, to generate the simplified display content.

4. The display method as claimed in claim 3, wherein the step of omitting road information that is not of a same geographic information layer, to which the route planned by the navigation system belongs, comprises:
selecting partial vertexes on the route from a database of the navigation system according to the route planned by the navigation system; and
linking the selected vertexes to form a route to be displayed.

5. The display method as claimed in claim 4, wherein the selected vertexes are a start point and an end point of the route.

6. The display method as claimed in claim 2, wherein the step of simplifying the display content by the navigation system in the normal operating mode comprises:
omitting information except a route planned by the navigation system and direction instruction signs to generate the simplified display content.

7. The display method as claimed in claim 6, further comprising:
adjusting the simplified display content to change a display manner of the direction instruction signs.

8. The display method as claimed in claim 2, further comprising:
updating the display screen according to a control command which comprises an instruction direction; and
correspondingly updating the display screen according to a direction from rotating the instruction direction with the predetermined angle.

9. A navigation system, comprising a normal operating mode and a simplified display mode, comprising:
a processing module, for generating display content comprising a plurality of geographic information layers of road information when the navigation system operates in the normal operating mode, and omitting partial geographic information layers to generate simplified display content when the navigation system operates in the simplified display mode; and
a display module, coupled to the processing module, for displaying the display content on a display screen in the normal operating mode, and for displaying the simplified display content on the display screen in the simplified display mode.

10. The navigation system as claimed in claim 9, wherein when the simplified content is displayed, the display module displays a result of having rotated the simplified display content with a predetermined angle on the display screen.

11. The navigation system as claimed in claim 10, wherein when the processing module simplifies the display content of the navigation system operating in the normal operating mode, the processing module omits road information that is not of a same geographic information layer to which a route planned by the navigation system belongs.

12. The navigation system as claimed in claim 11, wherein the processing module selects partial vertexes on the route from a database of the navigation system according to the route planned by the navigation system, and links the selected vertexes to form a route to be displayed.

13. The navigation system as claimed in claim 12, wherein the selected vertexes are a start point and an end point of the route.

14. The navigation system as claimed in claim 10, wherein when the processing module simplifies the display content of the navigation system operating in the normal operating mode, the processing module omits information except a route planned by the navigation system and a direction instruction sign.

15. The navigation system as claimed in claim 14, wherein the processing module further adjusts the simplified display content to change a display manner of the direction instruction sign.

16. The navigation system as claimed in claim 10, wherein the processing module further updates the display screen according to a control command, which comprises an instruction direction, and the processing module correspondingly updates the display screen according to a direction from rotating the instruction direction with the predetermined angle.
